(19) United States
(12) Patent Application Publication
(10) Pub. No.: US 2012/0036371 A1
(43) Pub. Date: Feb. 9, 2012

(54) Protection from cryptoanalytic side-channel attacks

(76) Inventor: Jan Hayek, Muenchen (DE)

(21) Appl. No.: 13/066,840

(22) Filed: Apr. 25, 2011

(30) Foreign Application Priority Data
Apr. 29, 2010 (DE) 10 2010 028 375.4

(51) Int. Cl. G06F 21/00

(52) U.S. Cl. 713/190

(57) ABSTRACT

A method for protecting a circuit configured for executing functional cryptographic operations according to execution instructions from cryptoanalytic side-channel attacks via differential power analysis (DPA), simple power analysis (SPA) or electromagnetic analysis (EM), includes execution of nonfunctional cryptographic operations in addition to the functional cryptographic operations for masking the functional cryptographic operations.

### BACKGROUND OF THE INVENTION

1. Field of the Invention

The present invention relates to a method for protecting a circuit equipped for executing functional cryptographic operations according to execution instructions from cryptoanalytic side-channel attacks, in particular via differential power analysis (DPA), simple power analysis (SPA) or electromagnetic analysis (EM) as well as a corresponding device, in particular a microprocessor.

2. Description of the Related Art

Although the present invention is described below primarily with respect to cryptosystems in automobiles, it should be emphasized that the measures according to the present invention are not limited to devices and methods used in the automotive field but may also be used in the entire field of information technology (IT).

Information technology is becoming increasingly important in the automotive field in particular. On the one hand, this relates to fundamental vehicle functions, such as engine control, brakes, steering, etc., but also to secondary functions such as immobilizer or airbag systems as well as applications such as online routing and so-called in-car entertainment.

Against this background, the topic of securing such IT applications is also becoming increasingly important. Areas in which such security is necessary include, for example, access control, theft protection, anonymity in networked vehicles, confidentiality and reliability of communication, so-called content protection (i.e., preserving digital copyrights) and legal aspects, for example, manipulation safety of trip recorders.

A threat to IT security may emanate from the vehicle owner, from maintenance personnel, or from an external third party having physical access to the vehicle.

Cryptographic methods are a central component of IT security applications. The unit to be protected (for example, an engine control unit or an infotainment unit) is usually provided with a secret cryptographic key. The units to be protected usually include a cryptographic microprocessor.

IT security in an automobile differs fundamentally from that in conventional computer networks. Resources in a motor vehicle are limited because only relatively weak embedded processors (e.g., 8- or 16-bit microcontrollers) are used. Many of the aforementioned attackers have physical access to the vehicle, which enables side-channel attacks, for example, as explained in greater detail below. Another problem in the field of automotive IT security is that once security gaps have been discovered (for example, secret keys that have been discovered by spying), they are difficult to close by subsequent modifications. Likewise, establishing adequate IT security in a motor vehicle is made difficult by the complex manufacturing procedures for modern automobiles involving numerous different parties (suppliers, manufacturers, dealers, and service personnel).

Side-channel attacks are cryptoanalytic methods which attack the physical implementation of a cryptographic system in a device (such as a chip card, a security token or a hardware security module of a control unit). The principle is based primarily on observing a corresponding cryptographic device, for example, a microprocessor during processing corresponding algorithms and on finding relationships between the particular data observed and the possible keys.

Power analysis methods investigate the power consumption of a microprocessor during cryptographic calculations. Power consumption varies depending on the particular microprocessor commands being executed. This allows inferences about executed operations as well as about the key on which they are based. The resulting “traces” (a certain quantity or number of power consumption measurements obtained by a cryptological operation over time) may be used to discover patterns, such as DES rounds or RSA operations. Differences in the particular traces allow inferences about the key used. In addition to the simple power analysis, the so-called differential power analysis (DPA) in particular also allows such inferences.

The electromagnetic analysis (EM) is based on a corresponding analysis of the electromagnetic radiation.

There are various known methods for preventing cryptographic attacks on security-restricted modules and cryptographic systems, but these usually do not yield the desired success or they are associated with increased costs and/or increased complexity of implementation.

There is thus a demand for simplified methods for protecting cryptographic circuits from side-channel attacks in particular, preferably protecting them from side-channel attacks by differential power analysis.

### BRIEF SUMMARY OF THE INVENTION

According to the present invention, a method is proposed for protecting a circuit equipped according to execution instructions for executing functional cryptographic operations from cryptoanalytic side-channel attacks, in particular by differential power analysis (DPA), simple power analysis (SPA) or electromagnetic analysis (EM) as well as a corresponding device.

The measures according to the present invention include the technical teaching of executing, in addition to functional cryptographic operations, nonfunctional cryptographic operations for masking the functional cryptographic operations.

Within the scope of the present invention, “functional cryptographic operations” are understood to be operations which are related to the functionality of a corresponding circuit. These may be, for example, cryptographic operations for encrypting commands of an engine control unit, a corresponding entertainment system or communication among users. “Nonfunctional cryptographic operations,” however, are understood to be operations which do not fulfill a functional purpose in the corresponding device or in the corresponding circuit but are based on, for example, randomly generated keys or simulated keys, or they supply random data. Such nonfunctional cryptographic operations may optionally also be referred to as so-called dummy operations. Within the scope of the present invention, such nonfunctional cryptographic operations are performed primarily or exclusively for masking the functional cryptographic operations, as mentioned above.

The methods of cryptoanalysis explained above are based on an averaging of messages obtained in order to separate random noise from systematic signals. Through the measures according to the present invention, this separation is made difficult for a potential attacker due to the execution of nonfunctional cryptographic operations in addition to the functional cryptographic operations. It thus becomes more difficult to uncover cryptographic keys, for example. It should be emphasized that the measures according to the present invention need not protect a corresponding circuit completely from such attacks. Instead it is regarded as adequate if the effort for one or more attacks is increased in a manner which makes it appear to a potential attacker that an attack would no longer be promising or would require too much effort. In other words, spying on a corresponding cryptographic key is made significantly more difficult by the insertion of nonfunctional cryptographic operations.

It may be regarded as particularly advantageous here that the implementation proposed according to the present invention does not alter the behavior of the cryptographic algorithm per se, so that none of the certifications (for example, FIPS, NESSIE, CRYPTREC, etc., within the scope of AES methods) are affected and all of them remain valid.

The present invention may also be used to particular advantage in an AES microprocessor or coprocessor of a hardware security module (HSM), for example, i.e., in a cryptosystem, which is used within the context of engine control units.

It is self-evident that the features mentioned above and those yet to be explained below may be used not only in the particular combination indicated but also in other combinations or alone without going beyond the scope of the present invention.

### BRIEF DESCRIPTION OF THE DRAWINGS

FIG. 1 shows a flow chart of a method according to an example embodiment of the present invention.

FIG. 2 shows a method step according to an example embodiment of the present invention.

FIG. 3 shows a schematic illustration of an example embodiment of a device according to the present invention.

### DETAILED DESCRIPTION OF THE INVENTION

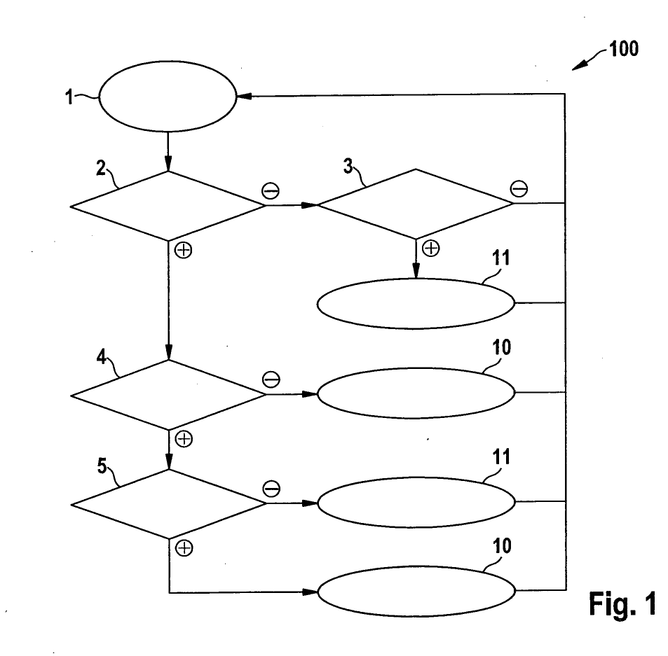

One example embodiment of the present invention is illustrated with reference to FIG. 1, in which a method 100 executed according to the specific embodiment is depicted schematically.

The embodiment of method 100 depicted in FIG. 1 includes two method steps or submethods which may be influenced and/or activated separately from one another.

At step 1, method 100 is in the basic state, i.e., idling.

In step 2 it is checked whether there has been an instruction for executing a functional cryptographic operation in a corresponding cryptosystem, i.e., an instruction to encrypt an electronic communication, for example. If this is not the case (indicated with “−” in FIG. 1, hereinafter referred to as the absence of execution instructions “2−”), then in another step 3, it is checked whether there has been a first request for execution of the nonfunctional cryptographic operations.

This instruction may be optionally activated or deactivated by the user or programmer of a corresponding device or a corresponding method. In particular it is considered here whether to randomly activate or deactivate an instruction depending on a random generator. The nonfunctional cryptographic operations may also be activated or deactivated for saving energy, for example. A system which detects an attempted decryption and then initiates or requests execution of nonfunctional cryptographic operations 11 may also be provided.

If it is found in step 3 that there is an instruction for executing the nonfunctional cryptographic operations (designated as “3+” as above), then random encryptions/decryptions are executed by a corresponding cryptoprocessor or a cryptography module. However, if nonexistence (3−) of the request for execution of the nonfunctional cryptographic operations 11 is detected, the system returns to basic state 1.

For the case when the existence (2+) of execution instructions for executing functional cryptographic operations is found in step 2, it is checked in step 4 whether there is a second request for execution of the nonfunctional cryptographic operations. This second request may also optionally be activated or deactivated. If there is no request (4−), then only a functional cryptographic function or operation 10, i.e., an encryption of a communication, is executed and the system then returns to basic state 1.

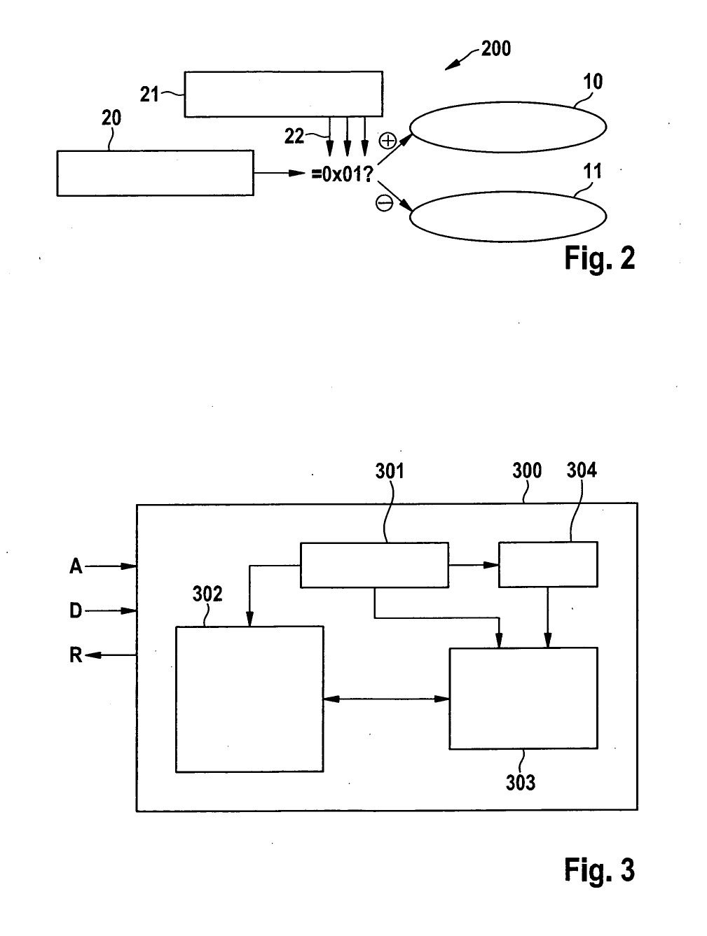

For the case when a corresponding second request exists (4+), a random condition may be inserted, as explained in FIG. 2 below. If the random condition is met (5+), functional cryptographic operation 10 is processed and the system returns to the basic state. However, if the random condition is not met (5−), a nonfunctional cryptographic operation 11 is executed and the system also returns to basic state 1. However, since an execution instruction for executing functional cryptographic operation 10 also exists in this case, the method again advances to step 5, namely until random condition 5 is met and functional cryptographic operation 10 is processed.

The random method represented in step 5 of FIG. 1 is illustrated in greater detail in FIG. 2 and is labeled as 200 on the whole. The method includes, for example, a random generator 21, which is equipped for generating 22 a random number having a certain bit length. The random number is compared (indicated with “=0x01?” in FIG. 2) with a previously defined and output number 20, which may be varied in the system. If the random number corresponds to the predefined number, the random condition is met (5+) and functional cryptographic operation 10 is executed. Otherwise the random condition is not met (5−) and a nonfunctional cryptographic operation 11 is executed. Those skilled in the art will understand that the ratio with which either functional cryptographic operation 10 on the one hand or nonfunctional cryptographic operation 11 on the other hand is executed is adjustable by the lengths (bit length) of the random number generated in 22 by random generator 21 and predefined number 20. The greater the bit length of a corresponding random number, which is compared with predefined number 20, the more rarely will a comparison of the two numbers yield an identity and thus result in execution of functional cryptographic operation 10. The degree of masking of functional cryptographic operations 10 may thus be set easily on the basis of the manipulation of the bit length of the random number and adapted to the particular requirements.

The measures according to the present invention may be summarized to the effect that nonfunctional cryptographic operations are executed in addition to functional cryptographic operations, namely in states of a corresponding system in which there are no execution instructions for the functional cryptographic operations as well as in situations in which there are corresponding instructions. In the latter case, these instructions are combined with nonfunctional cryptographic operations. The decision whether an actual (functional) or nonfunctional operation is executed is made by a random generator (for example, a continuously running LFSR (linear feedback shift register)) or by another random generator. Through the measures according to the present invention, in particular by setting the bit length of the random number, which is compared with the preset value, the number of measurements required for successful differential power analysis is significantly increased.

In particular a pseudo random generator (pseudo random number generator, PRNG) may be used advantageously within the scope of the present invention. Depending on the implementation, it is possible with a PRNG to ensure that the functional cryptographic operation is executed within a certain period of time or a certain number of queries.

FIG. 3 schematically shows a preferred specific embodiment of a device according to the present invention, which is labeled as 300. The device here is designed as an AES coprocessor 300, which may be used in cryptographic systems in control units in motor vehicles, for example. Coprocessor 300 has a series of data inputs D, data outputs R and address inputs A, in addition to other terminals (not shown).

Coprocessor 300 has, among other things, a state machine 301, which functions essentially to interpret the commands and to control the execution of these commands. Coprocessor 300 also has a memory module 302, for example, a RAM memory unit or a corresponding register memory. Coprocessor 300 also has a processing unit or cryptography unit 303 for processing tasks and a PRNG 304 for generating pseudo random numbers.

Within coprocessor 300, cryptography unit 303 executes functional cryptographic operations according to state machine 301, as explained with reference to FIGS. 1 and 2, and also executes nonfunctional cryptographic operations for masking the functional cryptographic operations.

What is claimed is:

1. A method for protecting a circuit, which is equipped for executing functional cryptographic operations according to execution instructions, from cryptoanalytic side-channel attacks via one of differential power analysis (DPA), simple power analysis (SPA) or electromagnetic analysis (EM), comprising:
executing the functional cryptographic operations; and
additionally executing nonfunctional cryptographic operations for masking the functional cryptographic operations.

2. The method as recited in claim 1, wherein the nonfunctional cryptographic operations are executed in the absence of execution instructions for executing the functional cryptographic operations and in the simultaneous presence of a first request for executing the nonfunctional cryptographic operations.

3. The method as recited in claim 1, wherein the nonfunctional cryptographic operations are executed in the presence of execution instructions for executing the functional cryptographic operations and in the simultaneous presence of additional execution conditions.

4. The method as recited in claim 3, wherein the additional execution conditions include a presence of a second request for executing the nonfunctional cryptographic operations.

5. The method as recited in claim 4, wherein the additional execution conditions include a random condition.

6. The method as recited in claim 5, wherein a frequency ratio between the execution of the functional cryptographic operations and the execution of the nonfunctional cryptographic operations is controlled by an adaptation of the random condition.

7. The method as recited in claim 6, wherein the random condition is supplied by using a value generated by a pseudo random generator.

8. A microprocessor device configured to protect from cryptoanalytic side-channel attacks via one of differential power analysis (DPA), simple power analysis (SPA) or electromagnetic analysis (EM), comprising:
a first cryptography unit configured to execute functional cryptographic operations according to execution instructions; and
at least one second cryptography unit configured to execute nonfunctional cryptographic operations to mask the functional cryptographic operations.

9. The microprocessor device as recited in claim 8, wherein the at least one second cryptography unit is configured to execute the nonfunctional cryptographic operations at least one of: (i) in the absence of execution instructions for executing the functional cryptographic operations and in the simultaneous presence of a first request for executing the nonfunctional cryptographic operations; and (ii) in the presence of execution instructions for executing the functional cryptographic operations and in the simultaneous presence of additional execution conditions.

10. The microprocessor device as recited in claim 9, wherein the first cryptography unit and the at least one second cryptography unit are identical.
